(19) United States
(12) Patent Application Publication
(10) Pub. No.: US 2009/0049923 A1
(43) Pub. Date: Feb. 26, 2009

(54) Method and Device for Controlled Compression Bat Rolling and a Composite Bat Barrel Broken-In By Such Method

(76) Inventor: Michael Rogers, Tarboro, NC (US)

Correspondence Address: THE PARKER LAW OFFICE, PLLC, 800 COUNTRY CLUB DRIVE, PO BOX 8334, ROCKY MOUNT, NC, 27804-1334, US

(21) Appl. No.: 12/044,081

(22) Filed: Mar. 7, 2008

Related U.S. Application Data
(60) Provisional application No. 60/906,549, filed on Mar. 13, 2007.

(51) Int. Cl. G01N 3/08

(52) U.S. Cl. 73/818

(57) ABSTRACT

A device and method for applying controlled compression to a composite bat includes a plurality of opposing rollers adapted to apply compressive force to a bat's barrel. Application of controlled compressive force to the barrel breaks-in the bat providing greater flexibility and improved performance. The barrel is drawn through a plurality of opposing rollers, rotated as needed, and redrawn through the rollers until the entire circumference of the barrel is affected by the controlled compression break-in process. Also, a composite bat barrel broke in using controlled compression rolling.

### BACKGROUND OF THE INVENTION

1. Field of the Invention

The invention relates generally to device and process for improving performance of a ball bat. The invention relates more specifically to a device and process for controlled compression of a composite ball bat to facilitate accelerated bat break-in.

2. Description of Related Art

Baseball and softball are competitive sports. Over the history of these sports, players and manufacturers have sought new methods of improving batting performance. In the past, such methods have included improved bat construction and material selection, engineered sweet spots, and improved weight distribution. Other methods include altering the manufacturer's original construction by machining to reduce wall barrel wall thickness, adding increased weights in the bat, and corking or inserting unapproved materials in the bat that differ from original construction materials.

The industry introduced composite bats to provide lighter bats with improved batting characteristics. Composite bats are primarily used in slow-pitch softball. Composite bats allow manufacturers increased flexibility in construction with the ability to tune or improve the trampoline effect associated with hollow bats construction. Players report that composite bat performance increases significantly after the bat is broken in through repetitive hitting and use. This results from break-down of the resin and fiber structure of the composite bat which increases flexibility. As flexibility increases, the “trampoline effect” common to hollow bats increases, resulting in faster batted ball speed. Broke-in bats are a valuable tool in permitting a player to hit balls faster and farther. Thus, players have the desire to break bats in quicker without spending the hours of practice use hitting balls to break the bat in.

Players use a variety of methods to break in bats faster. Players have found that hitting a composite bat's barrel repeatedly with a softer object, such as a rubber mallet or against a wooden pole, tends to break the bat in faster. Others recognized that wrapping the barrel in a protective cloth and then placing the barrel in a vice tends to break the bat in. However, these methods are crude, and can lead to excessive damage or breakage to an expensive composite bat. Additionally, there is no way to measure the forces applied to the bat with these techniques, and it would be almost impossible to ensure that the forces are applied evenly over the bat's entire barrel surface. Other methods, such as altering the bats construction as previously discussed, result in bats that are no longer sanctioned for regulation play.

Accordingly, what is needed is a device and method for breaking in a bat's barrel quicker and more evenly than regular hitting.

### BRIEF SUMMARY OF THE INVENTION

An object of the present invention is to provide a device and method for breaking in or “seasoning” a bat more quickly than regular hitting.

A further object of the present invention is to provide a device and method for breaking in the barrel of a composite bat.

Yet another object of the invention is to provide a means for controlling the force applied to the barrel during the break-in process.

Yet another object of the invention is to provide a uniformly broke-in composite bat barrel by compressive rolling method.

To achieve the forgoing objects, and in accordance with the purpose of the invention as broadly described herein, the present invention provides a device having a plurality of rollers, at least one of which is adjustable to provide controlled compression on a bat's barrel.

To further achieve the forgoing objects, the present invention provides a method of breaking in a bat's barrel using controlled compression applied to the barrel surface, and a bat barrel broke-in using such method.

In a preferred embodiment of the invention, a bat-rolling machine comprises a frame having a feed roller rotably mounted therein and powered by a drive means. A compression roller rotably mounts in a housing. The housing further is part of an elevation device. The two rollers are arranged to oppose each other. The elevation device operably connects to the frame so that the distance between the rollers may be varied, as well as to supply controlled compression to a bat's barrel fed between the rollers. The drive means of the illustrated embodiment is a hand operated drive handle operably connected to the feed roller. The elevation means is a threaded rod having a hand-operated elevation handle on one end, the housing on the other end. The frame further has a threaded hole that cooperates with the threaded rod, such that turning the elevation handle affixed to the threaded rod moves the rod through the threaded hole. This movement either drives the compression roller toward or away from the feed roller.

Other embodiments may include a plurality of rollers, including synchronously driven feed rollers, multiple adjustable rollers, or rollers having axes parallel or perpendicular to the bat's axis. Feed rollers may be hand driven or motor driven. Likewise the elevation means may be motor driven.

The present invention will now be described with reference to the following drawings, in which like reference numbers denote the same element throughout.

### BRIEF DESCRIPTION OF THE DRAWINGS

FIG. 1 is a perspective view of a device in which the current invention is practiced and having a bat's barrel disposed therein.

FIG. 2 is a side elevation with partial cutaway view of a device in which the current invention is practiced.

FIG. 3 is a front elevation view of a device in which the current invention is practiced.

FIG. 4(a-c) are exemplary operating conditions of the controlled compression break-in using perpendicular rollers.

FIG. 5 depicts exemplary operating conditions of the controlled compression break-in using parallel rollers.

FIG. 6 is a perspective view of exemplary operating conditions of the controlled compression break-in using parallel rollers.

### DETAILED DESCRIPTION OF THE INVENTION

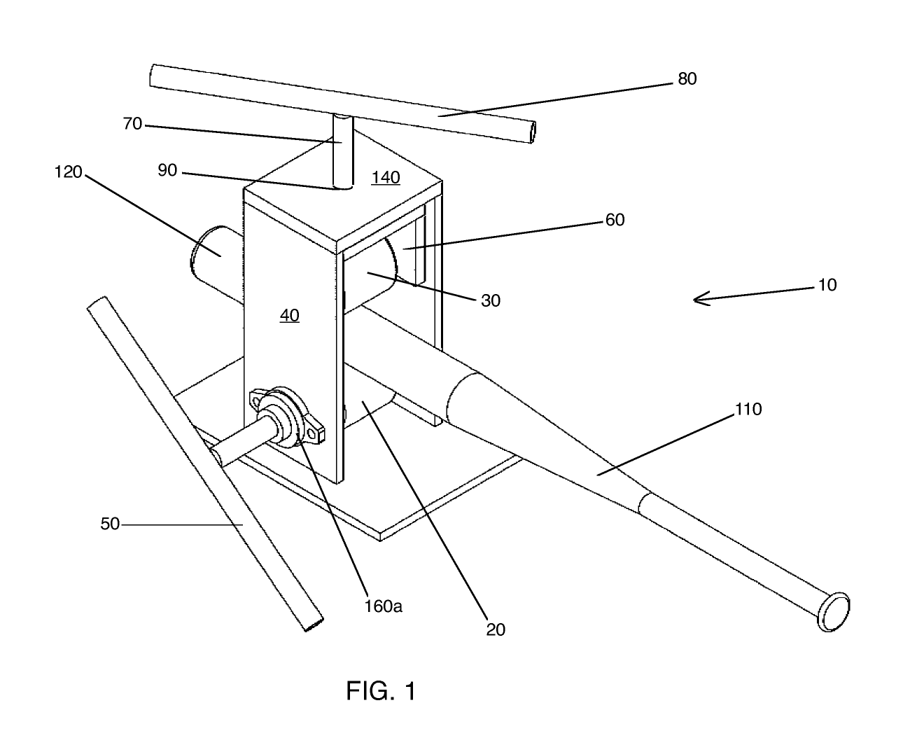

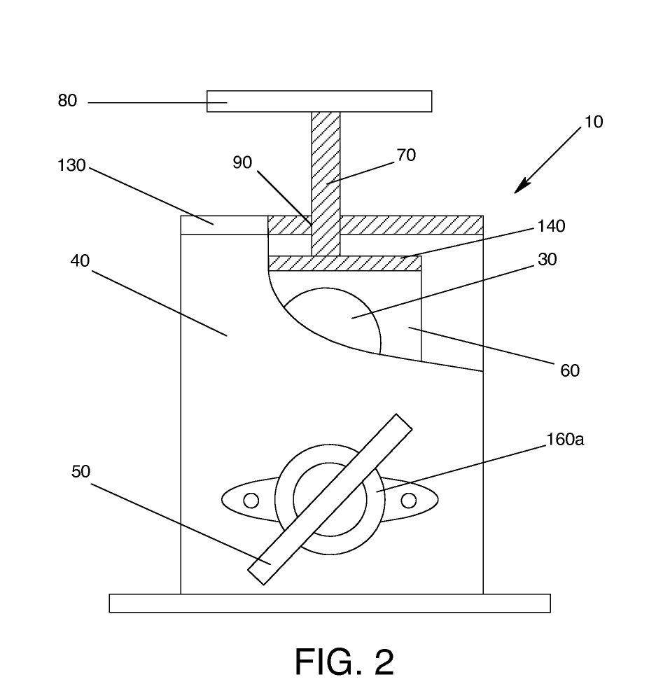

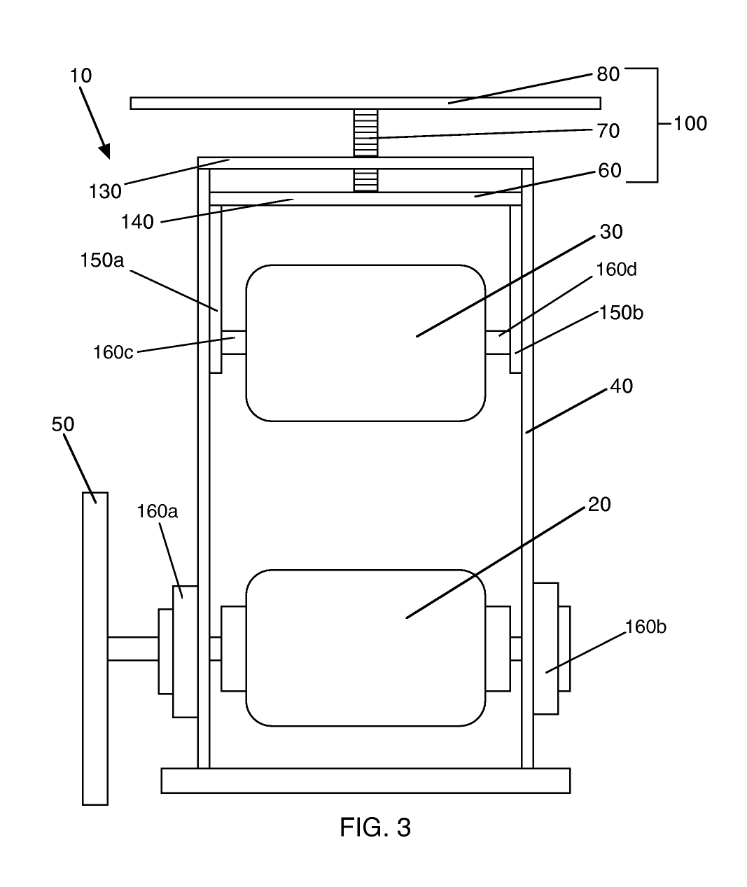

FIG. 1 through FIG. 3 depict a controlled compression bat 110 rolling device 10 used for controlled compression break-in of a composite bat 110. The illustrated embodiment utilizes a set of opposing rollers 20, 30 to apply constant and uniform force to a bat 110 barrel 120. The force should ideally be equal to or less than that applied to the bat 110 by a ball striking the bat 110 during actual play conditions. Application of controlled and uniform force to the composite barrel 120 increases flexibility and performance of the barrel 120. This flexibility tends to reduce the sting associated with hits outside of the bat's 110 sweet spot, as well as lower hoop frequency that improves the “trampoline effect” of hollow bats 110. Unlike hitting a ball with the bat 110 hundreds of times, the uniform compression provided by the rollers ensures that break-in is even along the barrel 120's entire surface, not just the point of impact with a ball.

The illustrated embodiment has a feed roller 20 and a compression roller 30 which may have metal or hard rubber contact surfaces. The feed roller 20 is rotably affixed to a simple body or frame 40 using appropriate mounting devices 160a, 160b, such as bearings. Body and frame 40 are used interchangeably throughout. As depicted, the frame 40 is a simple rectangular-box shape having an enlarged base for stability, to spaced-apart sides parralel to each other extending upwardly from the base. A top 130 affixes distally from the base to the sides. A known drive mechanism, such as the drive handle 50 operably connected to the feed roller 20 as depicted, drives the feed roller 20. The frame 40 is made of steel, but may be made from any other appropriate metal providing similar rigidity. The feed roller 20 is disposed between the frame's 40 two sides, and its axis is parallel to the plane of the frame's 40 base and top 130. The mounting devices 160a, 160b or bushings mount to each side of the frame providing a rotable mount for the feed roller 20 therebetween. Other drive mechanisms could include electric motors, or hydraulic or pneumatic drives operably connected to the feed roller 20. In the absence of a drive mechanism, the bat 110 could be pushed or pulled through the rollers 20, 30 by hand or by the use of other means to draw the bat 110 through the rollers 20, 30. The compression roller 30 rotably affixes to a housing 60 adapted to cooperably fit within the frame 40. The housing 60 depicted in the drawings comprises a rectangular top 140 having two sides 150a, 150b in spaced apart relation affixed to the bottom side of the top 140 generally forming a u-shaped bracket. The housing 60 sides 150a, 150b are perpendicular to the housing 60 top 140 and have appropriate mounting devices 160c, 160d such as bearings affixed thereto. The compression roller 30 is disposed between the housing 60 mounting devices 160c, 160d. A threaded rod 70 has one end affixed to the housing top 140 and the other end affixed to an elevation handle 80. The frame 40 has a threaded hole 90 centrally machined into the frame's 40 top 130 adapted to cooperate with the threaded rod 70. The threaded hole 90 receives the threaded rod 70. As the elevation handle 80 is turned the rod 70 moves the housing 60 and compression roller 30 relative to the feed roller 20 to increase or decrease the distance between the rollers 20, 30. In the depicted device, the compression roller 30 moves along a vertical path of travel. Collectively, the housing 60, rod 70, elevation handle 80, and threaded hole 90 form an elevation means 100 for controlling the distance between the rollers 20, 30. The elevation means 100 also provides control over the compressive force applied to the barrel 120. In operation, the barrel 120 is inserted between the rollers 20, 30 and the compression roller 30 is adjusted to apply a predetermined compressive force to the barrel 120 between the rollers 20, 30. Appropriate force for break-in is generally applied when the bat 110 begins to make a popping or snapping noise while under the compressive load. Markings may be applied to the frame 40 or threaded rod 70 to indicate the travel of the compression roller 30. Through a calibration process of measuring the force applied for certain markings, it is possible to determine the amount of compressive force applied by the rollers 20, 30 to the barrel 120. In this manner, one could pre-set the compression to a desired force ensuring the desired break-in force is used. Additionally, such markings would facilitate a gradual break-in process where the compressive force is initially minimal on the barrel 120, but is steadily increased with each pass to provide a more gradual break-in if desired.

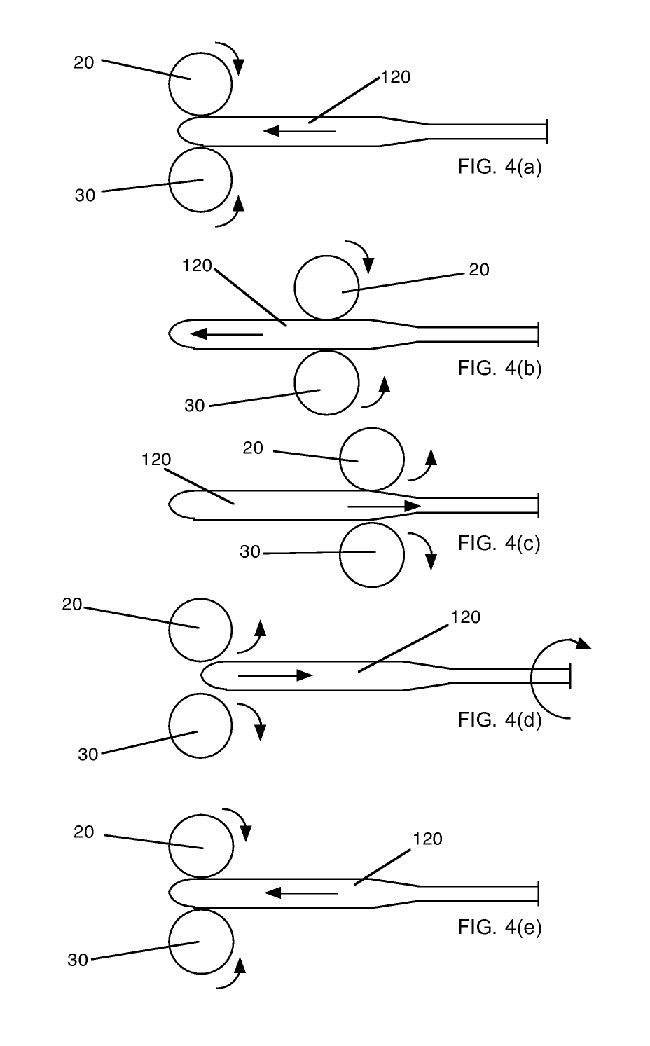

Once inserted between the rollers 20, 30 and compressive forces are applied to the barrel 120, the bat 110 is passed through the rollers 20, 30 to ensure that the compressive load is evenly applied and distributed longitudinally along the barrel's 120 surface. While the illustrated embodiment utilizes two rollers 20, 30, those skilled in the art will now appreciate that any number of rollers 20, 30 may be used at varying positions around the bat's 110 axis to compress the bat 110 at additional locations along the barrel's 120 circumference during rolling. The drive means or drive handle 50 is used to rotate the feed roller 20 and draw the barrel 120 through the rollers 20, 30. The general operation of passing the barrel 120 through the rollers 20, 30 is depicted in FIG. 4. When the barrel 120 is effectively “rolled” along its entire length, the barrel 120 can be removed from the device 10, rotated slightly in relatively consistent increments, and reinserted into the device 10 for a subsequent pass. This process of rolling and rotating is repeated until the entire circumference of the bat 110 is passed through the rollers 20, 30. Care should be taken to ensure that the compressive force applied to the bat 110 is not so great as to permanently distort or alter the original shape of the bat 110 once the compressive force is removed. Although the overall barrel 120 shape is unaffected, it is believed and understood that the micro-structure of the barrel's 120 composite fibers and resins are changed. Excessive pressure would result in fracture or barrel 120 breakage.

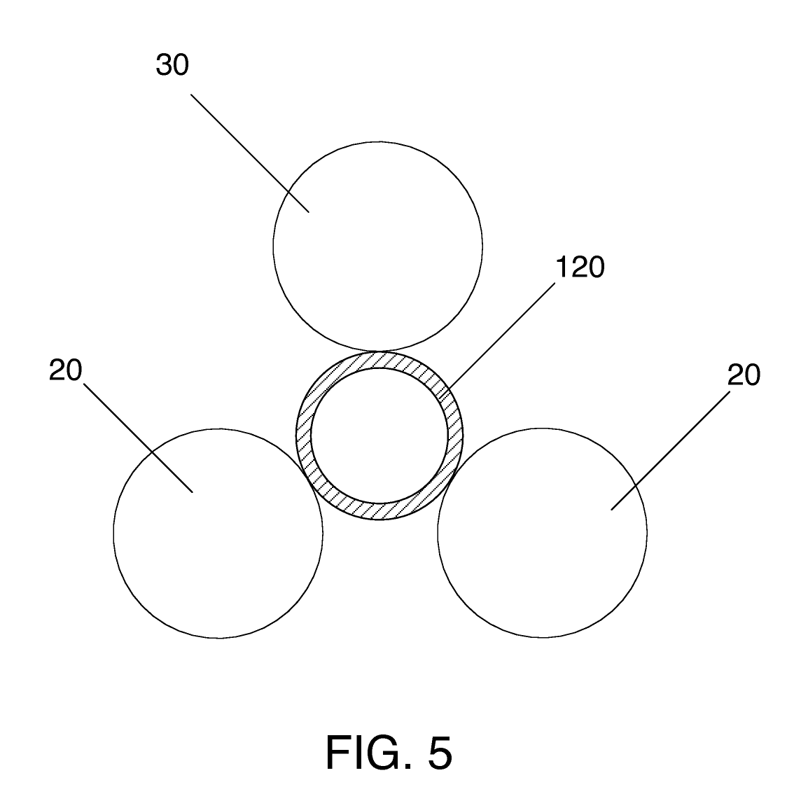

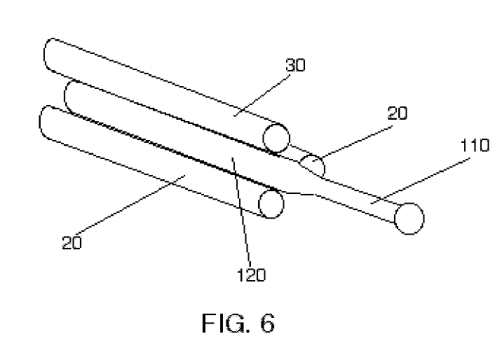

Alternative embodiments include a plurality of rollers 20, 30 positioned such that their axes are parallel to the bat's 110 axis as shown in FIG. 5 and FIG. 6. If this arrangement is used, the bat 110 would be interposed between the rollers 20, 30 and the compression roller 30 would be adjusted to apply compression to the barrel 120 in the same manner as previously described. However, instead of drawing the bat 110 through the rollers 20, 30, the bat 110 would be rotated within the rollers 20, 30. Such rollers 20, 30 would preferably be of equal or greater length than the barrel 120 to ensure that the entire barrel length is compressed at the points of contact with the rollers 20, 30 in one operation. The bat 110 may be rotated by hand or a feed roller 20 turned by a drive means. The bat 110 should be rotated in the device 10 so that all points along the barrel's 120 circumference are compressed to uniformly break the bat 110 in.

As can now be appreciated, this method produces a bat 110 having a uniformly broke-in barrel 120 and the resulting positive playing characteristics associated with the uniform break-in. This method produces broke-in bats 110 in significantly less time than would be needed through practice hitting, avoids the need to use harder balls that might potentially damage the bat 110, and avoids other methods where the break-in compressive force is not uniformly applied and distributed along the entire barrel 120.

As has been demonstrated, the present invention provides a novel device 10 and method for breaking in a baseball or softball bat's 110 barrel 120. The present invention can be used on a variety of composite bats 110. The prior art does not include teachings of break-in devices or methods as disclosed herein.

While the preferred embodiment of the present invention has been described, additional variations and modifications in that embodiment may occur to those skilled in the art once they learn of the basic inventive concepts. Therefore, it is intended that the appended claims shall be construed to include both the preferred embodiment and all such variations and modifications as fall within the spirit and scope of the invention.

I claim:

1. A controlled compression bat break-in device comprising:
a plurality of opposing rollers; wherein at least one roller is a compression roller affixed to an elevation means for adjusting the relative position of the compression roller and the compressive force applied to a bat barrel by the compression roller; wherein the plurality of rollers are adapted to receive and compress the bat barrel.

2. A controlled compression bat break-in device according to claim 1 wherein at least one of the plurality of rollers is a feed roller is operably connected to a drive mechanism.

3. A method for controlled compression break-in of a bat barrel comprising:
passing a bat barrel having a shape through a plurality of opposing rollers, the rollers positioned to apply uniform compression to the barrel along the length of the barrel, provided that the shape is essentially unchanged after passing the barrel through the rollers.

4. The method for controlled compression break-in according to claim 3 wherein the axis of the barrel and the axis of the rollers are perpendicular.

5. The method for controlled compression break-in according to claim 4 further comprising:
passing the barrel through a multiple of passes through the opposing rollers, and rotating the bat an increment after each pass to uniformly compress the barrel both longitudinally and circumferentially.

6. The method for controlled compression break-in according to claim 3 wherein the axis of the barrel and the axis of the rollers are parallel.

7. The method for controlled compression break-in according to claim 6 wherein passing further comprises interposing the barrel between the rollers; and rotating the barrel while applying the uniform compression.

8. A broke-in composite bat produced by the method of claim 3.

9. The method of claim 3 wherein at least one roller is a compression roller operably connected to an elevation means for controlling the compressive force applied to the barrel, such that the rollers apply a uniform predetermined compressive force to the bat barrel.
